(19) United States
(12) Patent Application Publication
(10) Pub. No.: US 2007/0288699 A1
(43) Pub. Date: Dec. 13, 2007

(54) System and method of protecting data in write-back cache between storage systems

(75) Inventors: Xing-jia Wang, Tianjin (CN); Jian-Feng Guo, Tianjin (CN); Cang-Mou Cao, Tianjin (CN); Yi Chen, Tianjin (CN); Tom Chen, Taipei (TW); Win-Harn Liu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/448,898

(22) Filed: Jun. 8, 2006

(51) Int. Cl. G06F 12/00

(52) U.S. Cl. 711/143

(57) ABSTRACT

A system of protecting data in write-back cache between storage systems and the method thereof are employed to protect data in the write-back cache between a first storage system and a second storage system. The system adds, updates, or deletes the data in the second storage system backed up from the write-back cache of the first storage system by monitoring operations on the write-back cache of the first storage system and sending a corresponding command to the second storage system in accord with the monitored operation. Therefore, the method ensures the consistency between the backup data and the data stored in the write-back cache of the first storage system, thereby increasing the security of the data.

### BACKGROUND OF THE INVENTION

1. Field of Invention

The invention relates to a data management system and a method thereof, and more particularly, to a system for protecting the data in the write-back cache between two storage systems and the method thereof.

2. Related Art

The cache memory is a faster internal storage unit, installed between slower system memory and the central processing unit (CPU). It is used to provide direct data access for the CPU, thereby increasing the data accessing speed of the CPU. The cache memory usually includes several memory blocks for storing data corresponding to the system memory.

The following two techniques are often employed to ensure data consistency between the cache memory and the system memory. The first technique is the write-through cache, whose control method is to directly write data into both the cache memory and the system memory. Therefore, the data consistency between them can be maintained. However, it takes more time to wait for the data to be written to the system memory. The second technique is the write-back cache, whose control method is to write the CPU data into the cache memory only. The status of the block that is being written is set as dirty. This method requires an additional action to ensure the data consistency. However, it saves a lot of time waiting for writing to the system memory. Moreover, the driver can optimize multiple writing operations. Therefore, the cache memory of ordinary computer systems adopts the write-back cache memory.

The disk cache item is each individual item in the disk cache of the storage system operating system (OS). Each disk cache item represents a physical memory page or block. In the storage system, the size of the disk cache is fixed as a constant. Therefore, the serial number of the disk cache item can be computed using the formula: (position of the disk cache item in the RAM)/(size of the disk cache item).

Due to its intrinsic properties, the write-back cache cannot effectively protect its data when abnormal situation such as power failure happens. This will result in user's loss.

### SUMMARY OF THE INVENTION

To solve the above-mentioned problems, an objective of the invention is to provide a system for protecting data in the write-back cache between two storage systems and the method thereof. It is used to protect the data stored in the write-back cache between a first storage system and a second storage system.

The disclosed system of protecting data in the write-back cache between two storage systems includes a first clear list, a first monitoring module, a first recording module, and a first command receiving and analyzing module. The first clear list is in a first storage system for recording the serial numbers of the disk cache items in the write-back cache of the first storage system where the data are already written in its storage device and need to be deleted. The first monitoring module is in the first storage system for monitoring operations on the write-back cache of the first storage system. When data stored in the disk cache are detected to be written to the storage device, it adds the serial number of the disk cache items to the first clear list. When the user is detected to store data in the disk cache, it reads the first clear list. When the first clear list is recorded with the serial number of the disk cache items to be deleted, a deletion command containing the serial number of the disk cache item to be deleted for each serial number is sent to the second storage system. The serial number is then deleted from the first clear list, until all the deletion commands for the corresponding serial numbers of the disk cache items to be deleted have been sent out and the serial numbers are all deleted. Afterwards, an addition or update command containing the information of the data content, the serial numbers of the disk cache items, the storage device numbers of the disk cache items to be written in, and the positions of the disk cache items in the storage device is sent to the second storage system. The first recording module is in the second storage system for backing up the data in the write-back cache of the first storage system. The first command receiving and analyzing module is in the second storage system for receiving and analyzing the command sent from the first monitoring module. When a deletion command is received, it deletes the corresponding data stored in the first recording module in accord with the analyzed command. When an addition or update command is received, it adds or updates the corresponding data in the first recording module in accord with the analyzed command.

To protect the data in the write-back cache of the second storage system, the invention further includes a second clear list, a second monitoring module, a second recording module, and a second command receiving and analyzing module. The second clear list is in a second storage system for recording the serial numbers of the disk cache items in the write-back cache of the second storage system where the data are already written in its storage device and need to be deleted. The second monitoring module is in the second storage system for monitoring operations on the write-back cache of the second storage system. When data stored in the disk cache are detected to be written to the storage device, it adds the serial number of the disk cache item to the second clear list. When the user is detected to store data in the disk cache, it reads the second clear list. When the second clear list is recorded with the serial numbers of disk cache items to be deleted, a deletion command containing the serial number of the disk cache item to be deleted for each serial number is sent to the first storage system. The serial number is then deleted from the second clear list, until all the deletion commands for the corresponding serial numbers of the disk cache items to be deleted have been sent out and the serial numbers are all deleted. Afterwards, an addition or update command containing the information of the data content, the serial numbers of the disk cache items, the storage device numbers of the disk cache items to be written in, and the positions of the disk cache items in the storage device is sent to the first storage system. The second recording module is in the first storage system for backing up the data in the write-back cache of the second storage system. The second command receiving and analyzing module is in the first storage system for receiving and analyzing the command sent from the second monitoring module. When a deletion command is received, it deletes the corresponding data stored in the second recording module in accord with the analyzed command. When an addition or update command is received, it adds or updates the corresponding data in the second recording module in accord with the analyzed command.

It is an advantage of the invention to protect the data in the write-back cache between two storage systems. When one of the storage systems is out of order, the data in its write-back cache can be restored to the storage device, achieving the goal of protecting the data in the write-back cache of the storage system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a system block diagram in accord with a preferred embodiment of the invention;

FIG. 2 is the flowchart of a processing program of the invention when detecting a user to store data to the disk cache of the first storage system;

FIG. 3 is the flowchart of a processing program of the invention when the data stored in the disk cache of the first storage system are detected to be written to the storage device;

FIG. 4 is the flowchart of a processing program of the invention when detecting the user to store data to the disk cache of the second storage system; and

FIG. 5 is the flowchart of a processing program of the invention when the data stored in the disk cache of the second storage system are detected to be written to the storage device.

### DETAILED DESCRIPTION OF THE INVENTION

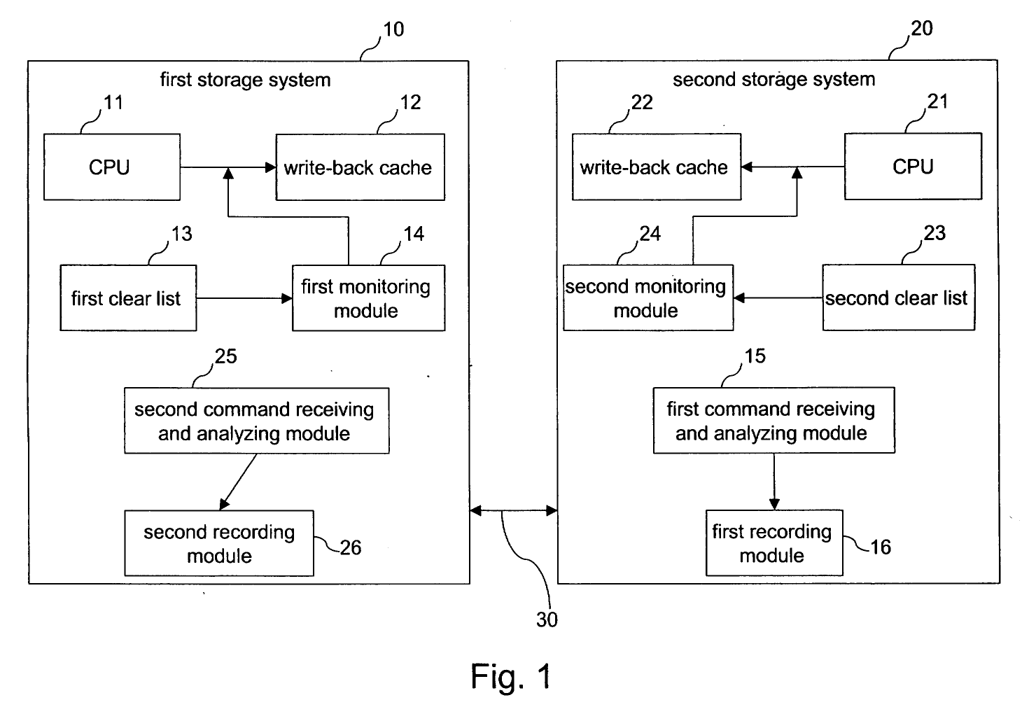

Referring to FIG. 1, the present invention system is used between a first storage system 10 and a second storage system 20 for protecting data in the cache of each other. The system includes: a first clear list 13, a first monitoring module 14, a first command receiving and analyzing module 15, a first recording module 16, a second clear list 23, a second monitoring module 24, a second command receiving and analyzing module 25, a second recording module 26, and an internal high-speed network 30.

The first clear list 13 is in the first storage system 10 for recording the serial numbers of the disk cache items in the write-back cache 12 of the first storage system 10 that need to be deleted. The first monitoring module 14 is in the first storage system 10 for monitoring operations on the write-back cache 12 of the first storage system 10. When data stored in the disk cache are detected to be written to the storage device, it adds the serial number of the disk cache item to the first clear list 13. When the CPU 11 is detected to follow the user's command to store data in the disk cache, it reads the first clear list 13. When the first clear list 13 is recorded with the serial numbers of disk cache items to be deleted, a deletion command containing the serial number of the disk cache item to be deleted for each serial number is sent to the first command receiving and analyzing module 15 of the second storage system 20. Afterwards, an addition or update command containing the information of the data content, the serial numbers of the disk cache items, the storage device numbers of the disk cache items to be written in, and the positions of the disk cache items in the storage device is sent to the first command receiving and analyzing module 15 of the second storage system 20. The first command receiving and analyzing module 15 is in the second storage system 20 for receiving and analyzing the command sent from the first monitoring module 14. When a deletion command is received, the first command receiving and analyzing module 15 deletes the data stored in the first recording module 16 of the second storage system 20 in accord with the serial number of the disk cache item to be deleted, wherein the data correspond to the data in the write-back cache 12 of the first storage system 10 When an addition or update command is received, the first command receiving and analyzing module 15 checks there are any data to be deleted in the target data page stores at first. If there are data to be deleted, then the data are deleted. Afterwards, the first command receiving and analyzing module 15 adds or updates the data in the first recording module 16 of the second storage system 20 in accord with the information of data content, the serial numbers of the disk cache items, the storage device numbers of the disk cache items to be written in, and the positions of the disk cache items in the storage device, wherein the data correspond to the data in the write-back cache 12 of the first storage system 10.

The second clear list 23 is in the second storage system 20 for recording the serial numbers of the disk cache items in the write-back cache 22 of the second storage system 20 that need to be deleted. The second monitoring module 24 is in the second storage system 20 for monitoring operations on the write-back cache 22 of the second storage system 20. When data stored in the disk cache are detected to be written to the storage device, it adds the serial numbers of the disk cache items to the second clear list 23. When the CPU 21 is detected to follow the user's command to store data in the disk cache, it reads the second clear list 23. When the second clear list 23 is recorded with the serial numbers of disk cache items to be deleted, a deletion command containing the serial number of the disk cache item to be deleted for each serial number is sent to the second command receiving and analyzing module 25 of the first storage system 10. Afterwards, an addition or update command containing the information of the data content, the serial numbers of the disk cache items, the storage device numbers of the disk cache items to be written in, and the positions of the disk cache items in the storage device is sent to the second command receiving and analyzing module 25 of the first storage system 10. The second command receiving and analyzing module 25 is in the first storage system 10 for receiving and analyzing the command sent from the second monitoring module 24. When a deletion command is received, the second command receiving and analyzing module 25 deletes the data stored in the second recording module 26 of the first storage system 10 in accord with the serial number of the disk cache item to be deleted, wherein the data correspond to the data in the write-back cache 22 of the second storage system 20. When an addition or update command is received, the second command receiving and analyzing module 25 checks there are any data to be deleted in the target data page stores at first. If there are data to be deleted, then the data are deleted. Afterwards, the second command receiving and analyzing module 25 adds or updates the data in the second recording module 26 of the first storage system 10 in accord with the information of data content, the serial numbers of the disk cache items, the storage device numbers of the disk cache items to be written in, and the positions of the disk cache items in the storage device, wherein the data correspond to the data in the write-back cache 22 of the second storage system 20.

The data in the write-back cache 12 of the first storage system 10 is backed up to the first recording module 16 in the second storage system 20. The data stored in the first recording module 16 and the data stored in the write-back cache 12 are consistent. Likewise, the data in the write-back cache 22 of the second storage system 20 is backed up to the second recording module 26 in the first storage system 10. The data stored in the second recording module 26 and the data stored in the write-back cache 22 are consistent. When the write-back cache 12 of the first storage system 10 is out of order, the first recording module 16 of the second storage system 20 can store the data of the write-back cache 12 of the first storage system 10 to the hard disk drive (HDD) of the first storage system 10 via the internal high-speed network 30 or other means (e.g., inserting the HDD of the first storage system 10 into the second storage system 20). This protects the data in the write-back cache 12 of the first storage system 10. Therefore, the data in the write-back cache 22 of the second storage system 20 can be protected likewise.

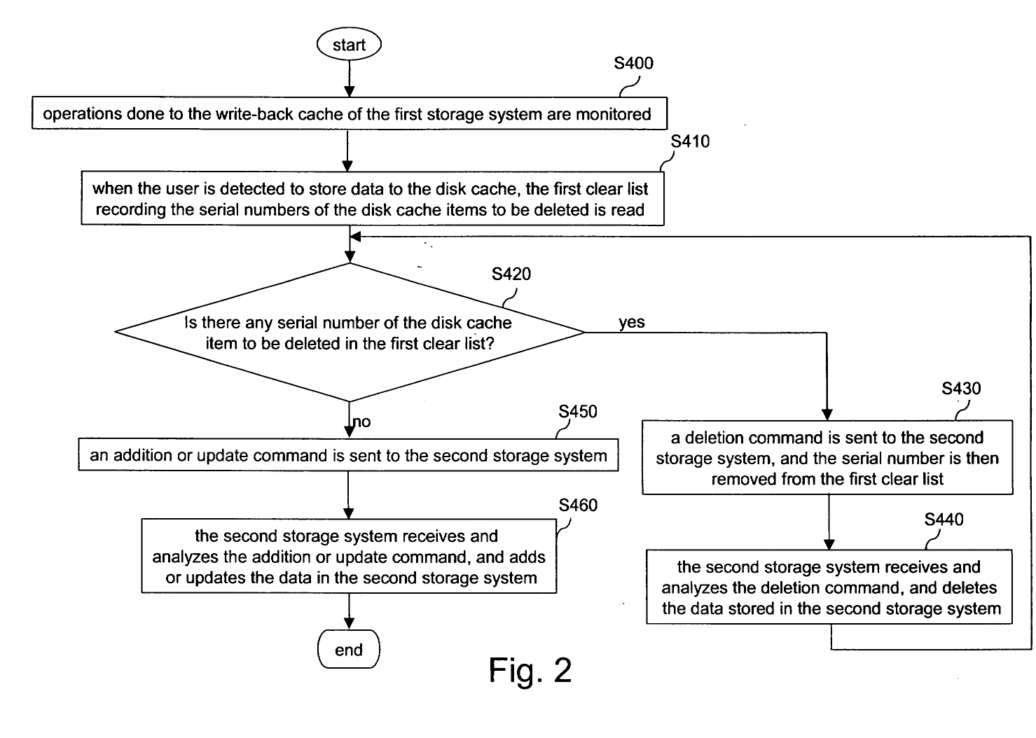

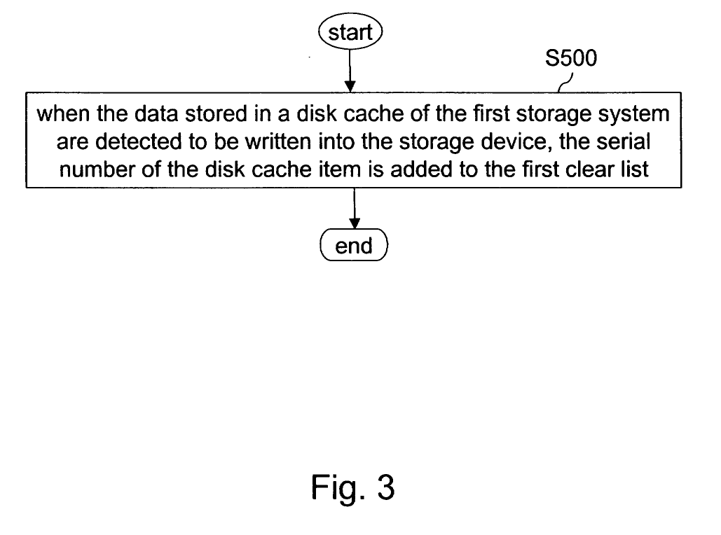

Please refer to FIGS. 2 and 3. As shown in the drawing, a preferred embodiment of the disclosed method is as follows.

Operations done to the write-back cache 12 of the first storage system 10 are monitored (S400). When the user is detected to store data to the disk cache, the first clear list 13 recording the serial numbers of the disk cache items that need to be deleted established in the first storage system 10 is read (S410). The system checks whether there is still any serial number of the disk cache item to be deleted in the first clear list 13 (S420).

When the first clear list 13 does not contain any serial number of the disk cache item to be deleted, step S450 follows. When the first clear list 13 still has some serial numbers of the disk cache items to be deleted, a deletion command containing the serial number of the disk cache item to be deleted for each serial number is sent to the second storage system 20. The serial number is then removed from the first clear list (S430). The second storage system receives and analyzes the deletion command, and deletes the data stored in the the second storage system 20 in accord with the serial number of the disk cache item contained in the deletion command, wherein the data correspond to the data in the write-back cache 12 of the first storage system 10 (S440), followed by step S420. An addition or update command containing the information of the data content, the serial numbers of the disk cache items, the storage device numbers of the disk cache items to be written in, and the positions of the disk cache items in the storage device is sent to the second storage system 20 (S450). The second storage system 20 receives and analyzes the addition or update command, and adds or updates the data to the second storage system 20 in accord with what contained in the addition or update command, including the information of the data content, the serial numbers of the disk cache items, the storage device numbers of the disk cache items to be written in, and the positions of the disk cache items in the storage device, wherein the data correspond to the data in the write-back cache 12 of the first storage system 10 (S460).

As shown in FIG. 3, when the data stored in a disk cache of the first storage system 10 are detected to be written into the storage device at any moment, the serial number of the disk cache item is added to the first clear list 13 (S500).

Using the above method, the data in the write-back cache 12 of the first storage system 10 are backed up to the second storage system 20. The data stored in the second storage system 20 and the data stored in the write-back cache 12 are consistent. When the write-back cache 12 of the first storage system 10 is out of order, the second storage system 20 can store the data in the write-back cache 12 of the first storage system 10 to the storage device of the first storage system 10 via the internal high-speed network 30 or some other means (e.g., inserting the HDD of the first storage system 10 into the second storage system 20). This protects the data in the write-back cache 12 of the first storage system 10.

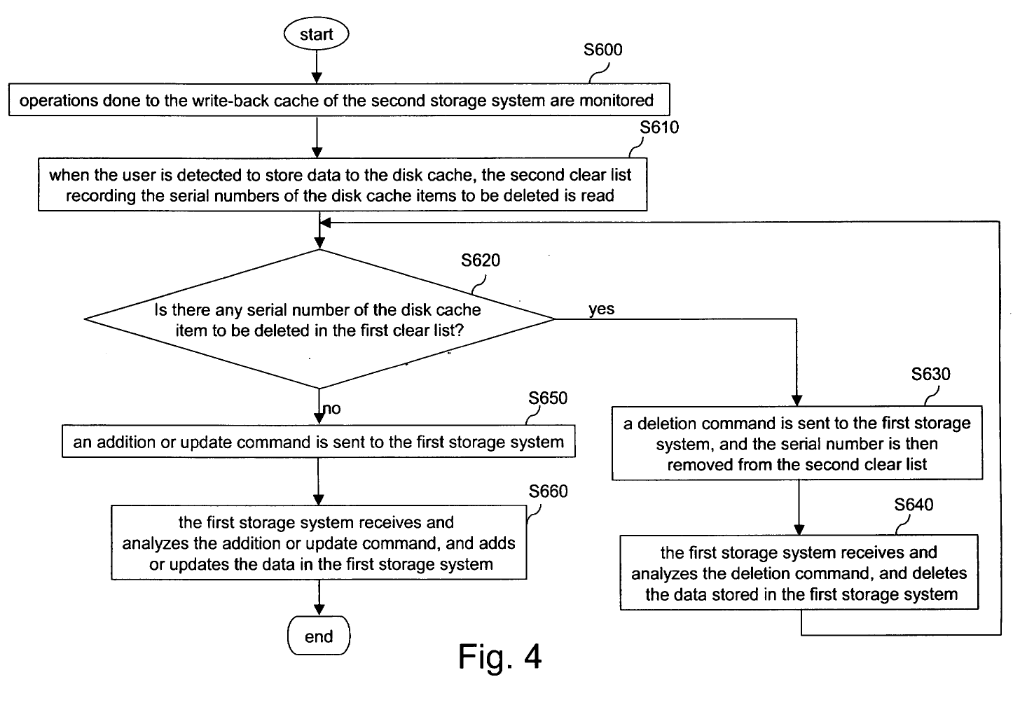

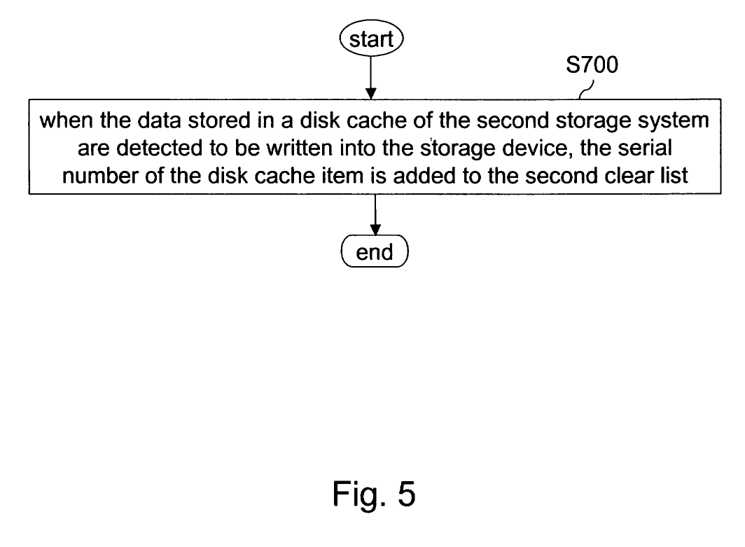

Please refer to FIGS. 4 and 5. As shown in the drawing, a preferred embodiment of the invention further includes the following steps.

Operations done to the write-back cache 22 of the second storage system 20 are monitored (S600). When the user is detected to store data to the disk cache, the second clear list 23 recording the serial numbers of the disk cache items to be deleted established in the second storage system 20 is read (S610). The system checks whether the second clear list 23 still has any serial number of the disk cache item to be deleted (S620).

When the second clear list 23 does not contain any serial number of the disk cache item to be deleted, step S650 follows. When the second clear list 23 still has some serial numbers of the disk cache items to be deleted, a deletion command containing the serial number of the disk cache item to be deleted for each serial number is sent to the first storage system 10. The serial number is then removed from the second clear list (S630). The first storage system receives and analyzes the deletion command, and deletes the data stored in the first storage system 10 in accord with the serial number of the disk cache item contained in the deletion command, wherein the data correspond to the data in the write-back cache 22 of the second storage system 20 (S640), followed by step S620. An addition or update command containing the information of the data content, the serial numbers of the disk cache items, the storage device numbers of the disk cache items to be written in, and the positions of the disk cache items in the storage device is sent to the first storage system 10 (S650). The first storage system 10 receives and analyzes the addition or update command, and adds or updates the data to the first storage system 10 in accord with what contained in the addition or update command, including the information of the data content, the serial numbers of the disk cache items, the storage device numbers of the disk cache items to be written in, and the positions of the disk cache items in the storage device, wherein the data correspond to the data in the write-back cache 22 of the second storage system 20 (S660).

As shown in FIG. 5, when the data stored in a disk cache of the second storage system 20 are detected to be written into the storage device at any moment, the serial number of the disk cache item is added to the second clear list 23 (S700).

Using the above method, the data in the write-back cache 22 of the second storage system 20 are backed up to the first storage system 10. The data stored in the first storage system 10 and the data stored in the write-back cache 22 are consistent. When the write-back cache 22 of the second storage system 20 is out of order, the first storage system 10 can store the data in the write-back cache 22 of the second storage system 20 to the storage device of the second storage system 20 via the internal high-speed network 30 or some other means (e.g., inserting the HDD of the second storage system 20 into the first storage system 10). This protects the data in the write-back cache 22 of the second storage system 20.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system of protecting data in write-back cache between storage systems for protecting data stored in the write-back cache between a first storage system and a second storage system, comprising:
a first clear list, which is in the first storage system for recording at least one serial number of a disk cache item in the write-back cache of the first storage system whose data have been written to the storage device and need to be deleted;
a first monitoring module, which is in the first storage system for monitoring an operation done to the write-back cache of the first storage system, and sends a deletion, addition, or update command to the second storage system in accord with the monitored operation;
a first recording module, which is in the second storage system for backing up the data in the write-back cache of the first storage system;
a first command receiving and analyzing module, which is in the second storage system for receiving and analyzing the command sent out by the first monitoring module, deletes the corresponding data stored in the first recording module when receiving the deletion command, and adds or updates the corresponding data in the first recording module when receiving the addition or update command;
a second clear list, which is in the second storage system for recording at least one serial number of a disk cache item in the write-back cache of the second storage system whose data have been written to the storage device and need to be deleted;
a second monitoring module, which is in the second storage system for monitoring an operation done to the write-back cache of the second storage system, and sends a deletion, addition, or update command to the first storage system in accord with the monitored operation;
a second recording module, which is in the first storage system for backing up the data in the write-back cache of the second storage system; and
a second command receiving and analyzing module, which is in the first storage system for receiving and analyzing the command sent out by the second monitoring module, deletes the corresponding data stored in the second recording module when receiving the deletion command, and adds or updates the corresponding data in the second recording module when receiving the addition or update command.

2. The system of protecting data in write-back cache between storage systems as claimed in claim 1, wherein the deletion command contains at least one serial number of the disk cache item to be deleted.

3. The system of protecting data in write-back cache between storage systems as claimed in claim 1, wherein the addition or update command contains: data content, serial numbers of the disk cache items, storage device numbers of the disk cache items to be written in, and positions of the disk cache items in the storage device.

4. A method of protecting data in write-back cache between storage systems for protecting data stored in the write-back cache between a first storage cache and a second storage cache, comprising the steps of:
monitoring operations done to the write-back cache of the first storage system;
reading a first clear list established in the first storage system for recording the serial numbers of the disk cache items to be deleted when a user is detected to store data to the disk cache;
sending a deletion command to the second storage system and deleting the serial number when the first clear list still contains any serial number of the disk cache item to be deleted;
receiving and analyzing the deletion command, and deleting the corresponding data stored in the second storage system in accord with the deletion command;
sending an addition or update command to the second storage system when the first clear list does not contain any serial number of the disk cache item to be deleted;
receiving and analyzing the addition or update command, and adding or updating the corresponding data in the second storage system in accord with the addition or update command; and
adding the serial number of the disk cache item to the first clear list when data stored in a disk cache is detected to be written to the storage device.

5. The method of protecting data in write-back cache between storage systems as claimed in claim 4, further comprising the steps of:
monitoring operations done to the write-back cache of the second storage system;
reading a second clear list established in the second storage system for recording the serial numbers of the disk cache items to be deleted when the user is detected to store data to the disk cache;
sending a deletion command to the first storage system and deleting the serial number when the second clear list still contains any serial number of the disk cache item to be deleted;
receiving and analyzing the deletion command, and deleting the corresponding data stored in the first storage system in accord with the deletion command;
sending an addition or update command to the first storage system when the second clear list does not contain any serial number of the disk cache item to be deleted;
receiving and analyzing the addition or update command, and adding or updating the corresponding data in the first storage system in accord with the addition or update command; and
adding the serial number of the disk cache item to the second clear list when data stored in a disk cache is detected to be written to the storage device.

6. The method of protecting data in write-back cache between storage systems as claimed in claim 4, wherein the deletion command contains at least one serial number of the disk cache item to be deleted.

7. The method of protecting data in write-back cache between storage systems as claimed in claim 4, wherein the addition or update command contains: data content, serial numbers of the disk cache items, storage device numbers of the disk cache items to be written in, and positions of the disk cache items in the storage device.
